(19) United States
(12) Patent Application Publication
(10) Pub. No.: US 2013/0067335 A1
(43) Pub. Date: Mar. 14, 2013

(54) METHOD AND APPARATUS FOR CREATING, MANIPULATING, AND COMMUNICATING STRATEGIC BUSINESS INITIATIVES

(71) Applicant: Jeff Hartweg, Bloomington, IL (US)

(72) Inventor: Jeff Hartweg, Bloomington, IL (US)

(73) Assignee: BURWOOD GROUP, INC., Chicago, IL (US)

(21) Appl. No.: 13/229,614

(22) Filed: Sep. 9, 2011

(51) Int. Cl. G06F 3/01

(52) U.S. Cl. 715/730

(57) ABSTRACT

Methods and apparatuses are provided that allow a user to achieve a high level articulation of business strategy at various levels, and appropriate links to supporting strategic initiatives. Additionally, real-time publishing of corporate strategy focus areas and directions is also made possible, as well as effective and efficient communications across the various levels of a company. Further still, users, such as, e.g., line managers, are provided the ability to develop effective budgets that are commensurate with developed business strategies/long term plans.

### TECHNICAL FIELD

The present application relates generally to interactive tools in mobile devices and, more particularly, to a tool for creating, manipulating, and communicating strategic business initiatives.

### BACKGROUND

Issues that commonly arise when leading organizations include general management issues and operational issues. With regard to general management, it has been observed that company leaders, such as executives, managers, supervisors, etc., often find defining particular business strategies, as well as defining the importance of such strategies to the success of the company, to be rather difficult. Additionally, such leaders often lack the capacity and/or time needed to conceptualize and actually develop business strategies that include specific objectives instead of mere abstract ideas or sweeping, generalized mission statements. Disseminating and effectively communicating business strategies to the intended persons, business units, etc. also often presents problems for those in leadership roles.

For example, and according to certain surveys, only slightly more than half the number of employees surveyed are able to state a company's business strategy, even when those employees are involved in strategy development. The number falls far below half for those employees not involved in strategic development. According to other survey statistics, less than half of the respondents surveyed believe that their particular organization is effective at developing business strategies, where those respondents are actually involved in strategy development. Again, and for those respondents that are not involved in strategy development, the number is far less than half. Moreover, certain statistics indicate that employees overwhelming believe effective/clear communication of strategies to be the most important aspect of strategy execution.

As to the aforementioned operational issues, organizations meet with problems when trying to effectively collaborate between teams to, e.g., quickly align resources and processes to meet business strategy objectives. The prioritization and alignment of budget to key business issues, as well as achieving an effective “return on interest” of initiatives across multiple business units also presents problems for organizational leaders. Moreover, operational issues may also include one or more of the following: spending an appropriate amount of money, time, and/or resources to achieve strategic objections quickly; duplicating work due to a lack of effective communication between leaders, personnel, etc.; and wasted funds/lost revenue as a result of work stoppages/delays in light of strategic changes or shifts in focus.

Certain existing business tools focus on management and monitoring, e.g., software developed by ActiveStrategy® and Information Builders, Inc. that includes process, performance, and task management and scoring/analytics. Such software may be said to effectuate “enterprise resource planning” (ERP), i.e., internal and external management information integration. Other tools, such as Microsoft Project® and Oracle® Primavera® are focused primarily upon project portfolio management, e.g., project execution and/or reporting. Therefore, a need exists for interactive strategy development creation, manipulation, and communication.

### SUMMARY

Various aspects of examples of the invention are set out in the claims.

According to a first aspect, a method comprises presenting, on an electronic display, a representation of a strategy relative to a timeline including first strategy data and second strategy data, wherein the second strategy data is aligned with the first strategy data. The method further comprises at least one of manipulating and communicating the representation of the strategy in real time in response to user input.

According to a second aspect, a computer-readable memory includes computer executable instructions, the computer executable instructions, which when executed by a processor, cause an apparatus to: present, on an electronic display, a representation of a strategy relative to a timeline including first strategy data and second strategy data, wherein the second strategy data is aligned with the first strategy data; and at least one of manipulate and communicate the representation of the strategy in real time in response to user input.

According to a third aspect, an apparatus comprises at least one processor and at least one memory. The at least one memory includes computer program code, the at least one memory and the computer program code configured to, with the at least one processor, cause the apparatus to perform at least the following: present, on an electronic display, a representation of a strategy relative to a timeline including first strategy data and second strategy data, wherein the second strategy data is aligned with the first strategy data; and at least one of manipulate and communicate the representation of the strategy in real time in response to user input.

### BRIEF DESCRIPTION OF THE DRAWINGS

For a more complete understanding of example embodiments, reference is now made to the following descriptions taken in connection with the accompanying drawings in which:

FIG. 1 is a representative diagram of exemplary business level perspectives in relation to a top level strategy in accordance with one embodiment;

FIG. 2 illustrates an exemplary roadmap in accordance with one embodiment;

FIG. 3 illustrates an exemplary roadmap in accordance with another embodiment;

FIG. 4 illustrates yet another exemplary roadmap and associated data box in accordance with one embodiment;

FIG. 5a illustrates an exemplary main menu displayed on an electronic device upon which one embodiment may be implemented;

FIG. 5b illustrates an exemplary settings page displayed on an electronic device upon which one embodiment may be implemented;

FIG. 5c illustrates an exemplary document browser displayed on an electronic device upon which one embodiment may be implemented;

FIG. 5d illustrates an exemplary roadmap editor displayed on an electronic device upon which one embodiment may be implemented;

FIG. 6 illustrates an exemplary system architecture in accordance with a standalone application implementation embodiment;

FIG. 7 illustrates an exemplary system architecture in accordance with a localized collaboration implementation embodiment;

FIG. 8 illustrates an exemplary system architecture in accordance with a cloud-based implementation embodiment; and

FIG. 9 is a flow chart illustrating exemplary processes performed in operating strategy tool in accordance with various embodiments.

### DETAILED DESCRIPTION

In accordance with various embodiments, methods and apparatuses are provided that allow a user to achieve a high level articulation of business strategy at various levels, and appropriate links to supporting strategic initiatives. Additionally, real-time publishing of corporate strategy focus areas and directions is also made possible, as well as effective and efficient communications across the various levels of a company. Further still, users, such as, e.g., line managers, are provided the ability to develop effective budgets that are commensurate with developed business strategies/long term plans. It should be noted that although various embodiments are described herein within a corporate or business context, various embodiments may be utilized in any scenario, setting, or context where strategic planning may be utilized.

As indicated above, proper communication of business strategies is paramount to effective organizational leadership. Communication strategy begins with coordinating efforts between business units and subsidiaries. For example, a “top level” strategy may be developed at the highest level of an organization, business, etc., e.g., the CxO level. Such a top level strategy may then be shared with other personnel/corporate levels, while lower level strategies or initiatives can be aligned to the top level strategy. Business unit-level views or perspectives may contain strategies/initiatives that are aligned with the top level strategy, but may also include unaligned strategies/initiatives that enable the BU to function within its particular market space, geography, etc.

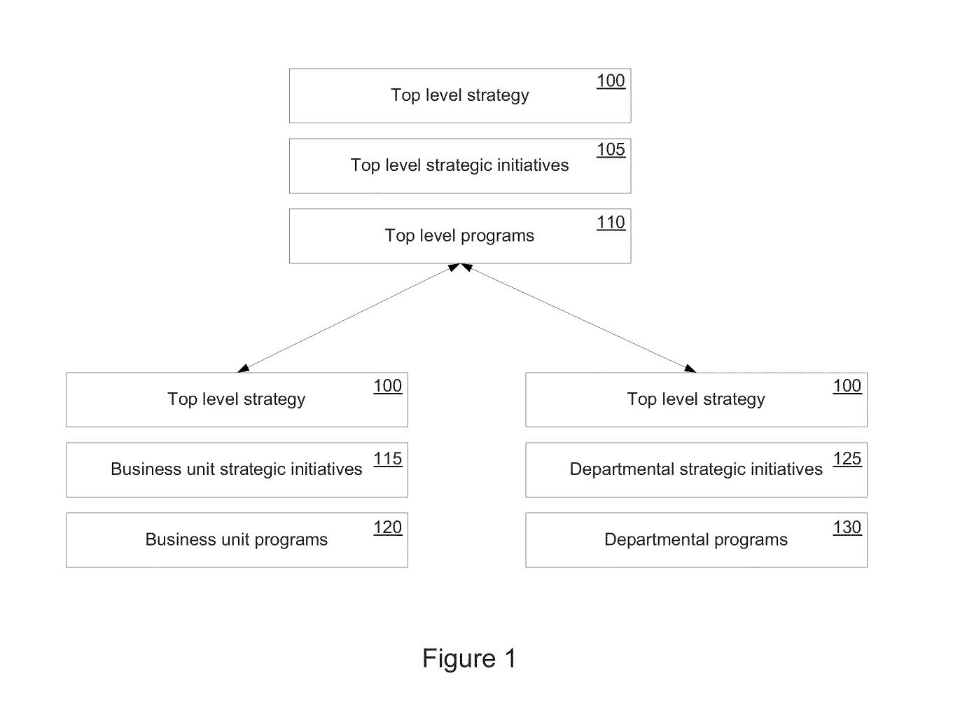

FIG. 1 illustrates a representative diagram of exemplary views or business level perspectives in relation to a top level strategy in accordance with one embodiment. As shown in FIG. 1, a top level strategy 100, along with top level strategic initiates 105 and top level programs 110, may make up a CxO-level perspective of a business strategy. As also shown in FIG. 1, a business unit view may include business unit strategic initiatives 115 and business unit programs 120 that are aligned with the top level strategy 100. Likewise, a departmental view may include departmental strategic initiatives 125 and departmental programs 130 that are aligned with the top level strategy 100.

Thus, from a conceptual standpoint, various embodiments may be used to create, adapt, manipulate, and ultimately communicate one or more strategies across an organization. It should be noted that the methods and apparatuses disclosed herein may be utilized using a “top-bottom” approach as illustrated in FIG. 1, or alternatively, from a “bottom-top” approach, as is appropriate for any particular scenario. It should also be noted that as will be discussed in greater detail below, aspects of the various perspectives may be interchanged. For example, the CxO-level view may be altered such that the top level strategic initiatives 105 and the top level programs 110 are interchanged with the business unit strategic initiatives 115 and the business unit programs 120, respectively.

To effectuate the creation, manipulation, and ultimately, the communication of strategies, various embodiments may be implemented on a variety of electronic devices including, but not limited to mobile devices, such as a tablet PC, Apple iPad®, etc. The use of such electronic devices provides a unique platform in that a large amount of data may be represented merely by, e.g., scrolling, pinching, sliding, etc., one or more representations of one or more strategies. Thus, in contrast to traditional methods of strategic planning/visualization, which require large scale plots and result in static/physical documents, business strategies may be visualized, easily adapted according to a user's needs, and easily associated or aligned with other strategic plans, initiatives, programs, etc. For example, a user, such as a business executive, is able to update strategic information on the fly and to enable collaboration, validation, and real-time updates to strategic plans.

As described herein, a “roadmap” refers to a timeline-based representation of particular business strategy data (whether or not aligned, as will be discussed in greater detail below), through the use of elements within “swimlanes.” These elements, when combined, present a visualization of the evolution of a business strategy over time. A roadmap may contain one or more swimlanes that articulate a particular business strategy, as well as, e.g., certain initiatives that are to be undertaken in order to accomplish the particular business strategy. The timeline aspect of a roadmap may be based on any desired period of time, such as a calendar or fiscal year, preferably divided into segments, such as yearly quarters, such that a business strategy and its associated initiatives may be mapped out in relation to, e.g., desired completion, benchmark, etc.

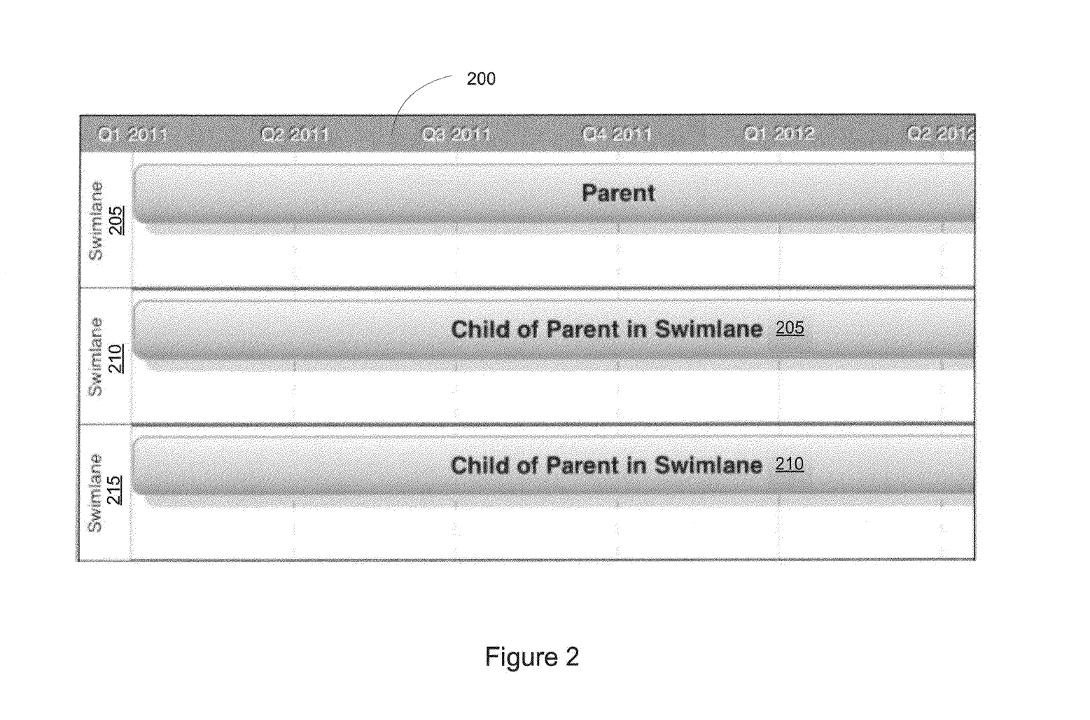

FIG. 2 illustrates an exemplary roadmap in accordance with one embodiment. A timeline 200 is divided into yearly quarters, e.g., first (Q1), second (Q2), third (Q3), and fourth (Q4) quarters. A first swimlane 205 may represent a parent strategy, e.g., a top level strategy, referring back to FIG. 1. Second and third swimlanes, 210 and 215, respectively, may represent child swimlanes. The top level strategy represented by swimlane 205 may refer to the business strategy itself, whereas the child swimlane 210 may refer to certain initiatives identified as being required to achieve the business strategy. Child swimlane 215 may contain/refer to other data, such as business unit strategies that may or may not be aligned with the top level strategy of parent swimlane 205, or may contain/refer to additional initiatives applicable to, e.g., lower level personnel or departments of a company, a company's subsidiaries, etc. It should be noted that swimlanes and their corresponding data may be added or deleted as needed to suit one or more business strategies.

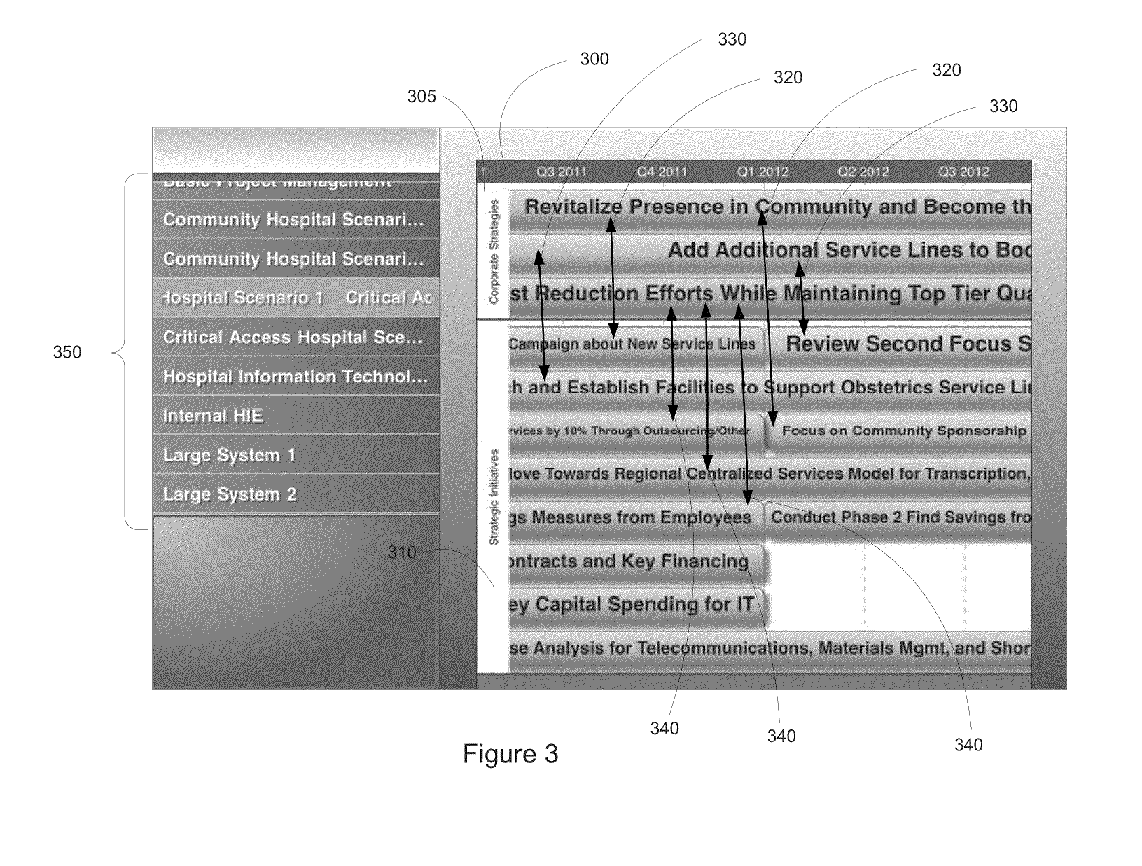

FIG. 3 illustrates another exemplary roadmap comprising, in this instance, a quarterly timeline 300, and a top level strategy (contained in swimlane 305) indicative of certain corporate hospital business strategies, including but not limited to, revitalizing community presence, adding additional service lines, etc. has been created in accordance with one embodiment. Additionally, lower level related strategies (contained in swimlane 310) indicative of certain strategic initiatives have also been created. With regard to creating a roadmap, and as will be discussed in greater detail below, a menu of templates or pre-defined roadmaps may be provided to a user through a template menu 350.

As alluded to previously, strategic elements such as strategic initiatives may be aligned with a higher level strategy. Thus, in accordance with various embodiments, a roadmap may contain two swimlanes. The top level swimlane may be an articulation of the “what,” i.e., a strategy itself, while lower level swimlanes may be an articulation of the “how,” i.e., the initiatives needed to effectuate the ultimate strategy.

In this instance, FIG. 3 illustrates that certain strategic initiatives in strategic initiatives swimlane 310 are aligned (e.g., related or associated with) a corporate strategy in swimlane 305. Arrows 320, 330, and 340 illustrate the alignment between the various corporate strategies with the various strategic initiatives. As can be seen, any number of alignments can be created, and to assist in visualizing such alignments, the strategic initiatives and the corporate strategies may be colored or shaded similarly, or otherwise presented in a manner suggesting that an alignment exists. For example, a first color may be used to indicate a first corporate strategy and one or more strategic initiatives aligned with that first corporate strategy, while a second color may be used to indicate a second corporate strategy and one or more strategic initiatives aligned with that second corporate strategy.

It should be noted that such alignment visualization aids in allowing a user to easily see and understand how, e.g., strategies and initiatives fit or affect a company across multiple organizational units. Moreover, the visualization of alignment(s) between strategies and initiatives also helps to ensure that personnel understand and provide guidance to allow working towards the ultimate business strategy. Further still, showing alignment(s) also provides a basis for project funding at lower corporate levels.

As an alternative to aligned initiatives, unaligned initiatives may also be created. Unaligned initiatives may include items or elements that are relevant or important, but not necessarily related to any particular strategy. For example, businesses often encounter initiatives that involve significant capital expenditure or human resources, e.g., information technology maintenance, key training for employees, and/or compliance activities. Such unaligned initiatives may be included in a swimlane, such as swimlane 310, but presented in, e.g., a neutral color, or with/having some other distinguishing characteristic(s).

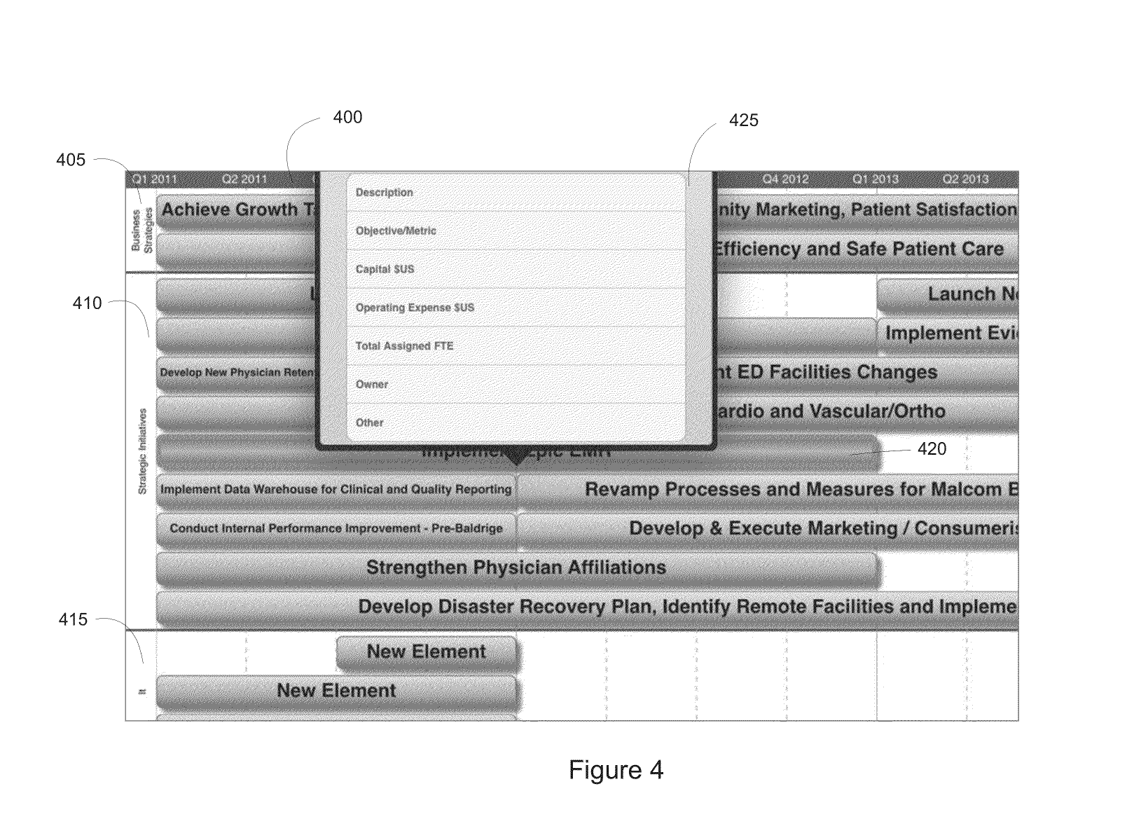

FIG. 4 illustrates yet another exemplary roadmap having a quarterly timeline 400, and three swimlanes, 405, 410, and 415. In accordance with various embodiments, any element or aspect of the roadmap may have additional information or data associated the element or aspect. For example, FIG. 4 illustrates a data box 425 that may be accessed by, e.g., double-tapping, an element such as strategic initiative 420 presented in swimlane 410. Such data may be thought of as “metadata” for that element, e.g., a more detailed description of the initiative, cost associated with the initiative (e.g., capital expenditures and operating expenses), owner/creator information, objective/metric data, assigned full-time equivalents (FTEs), etc. Such data may be pre-defined/pre-configured depending on the type of strategy or initiative element at issue, or may be configured by a user as desired. Additionally, accessing such data is not limited to double-tapping an element. Depending on the particular device and/or display upon which the roadmap is presented, an element may be selected, touched, swiped, pointed to, etc. Additionally, other aspects of the roadmap may have other data associated therewith.

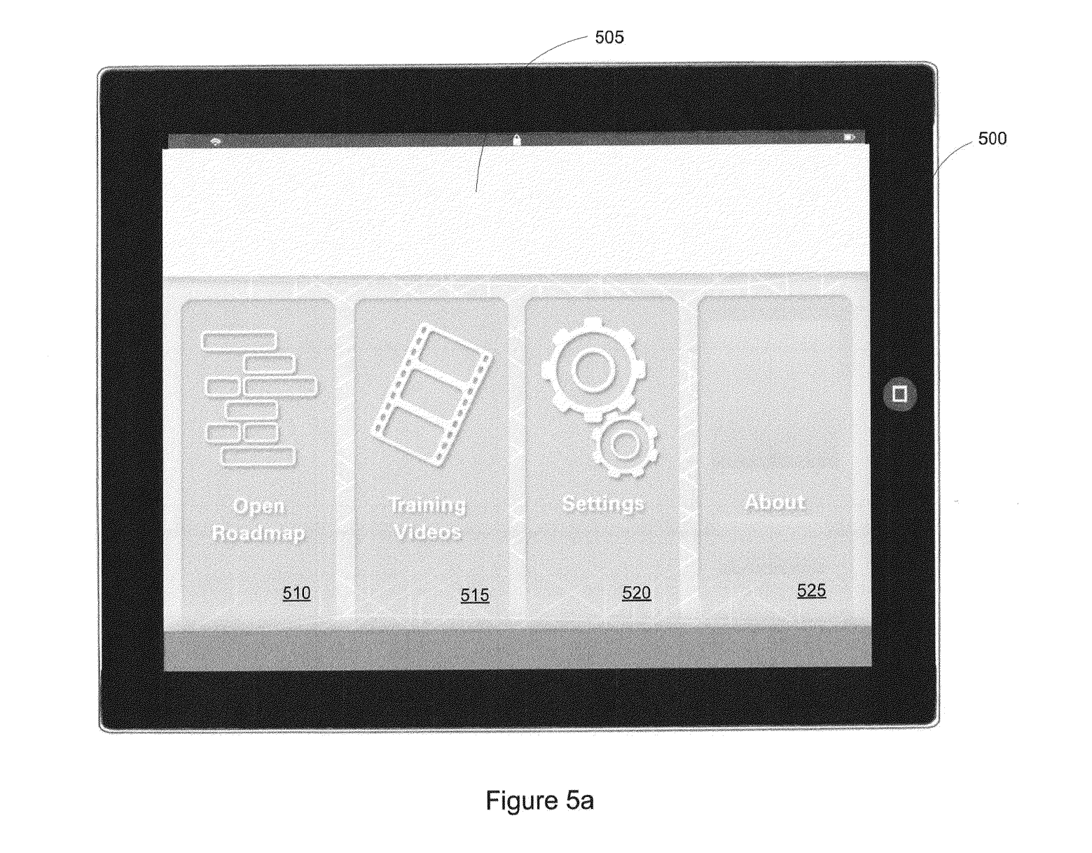

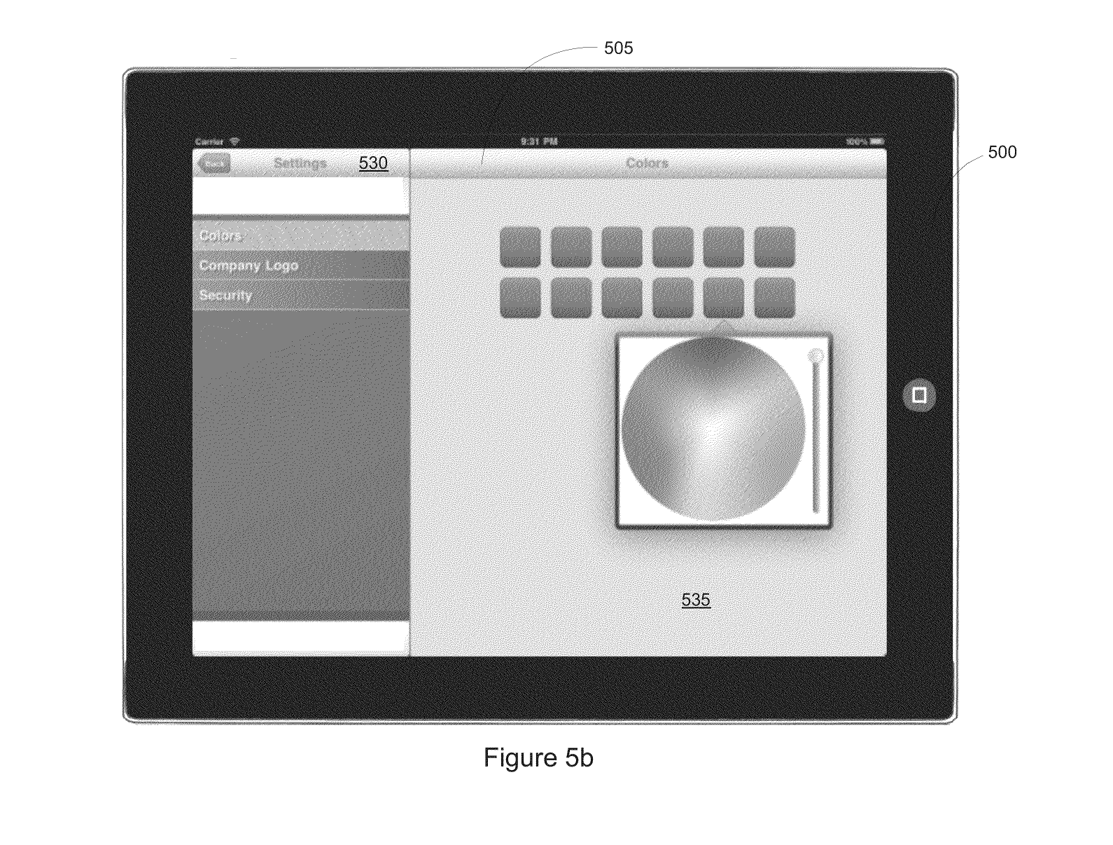

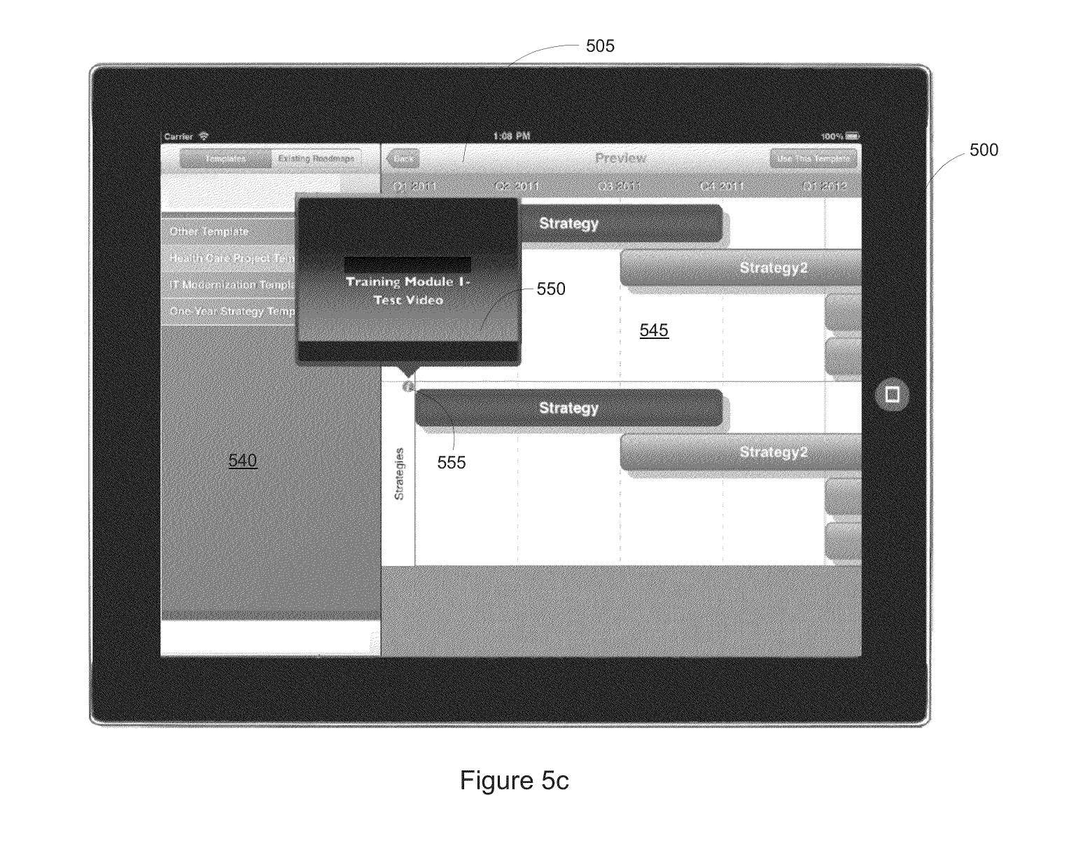

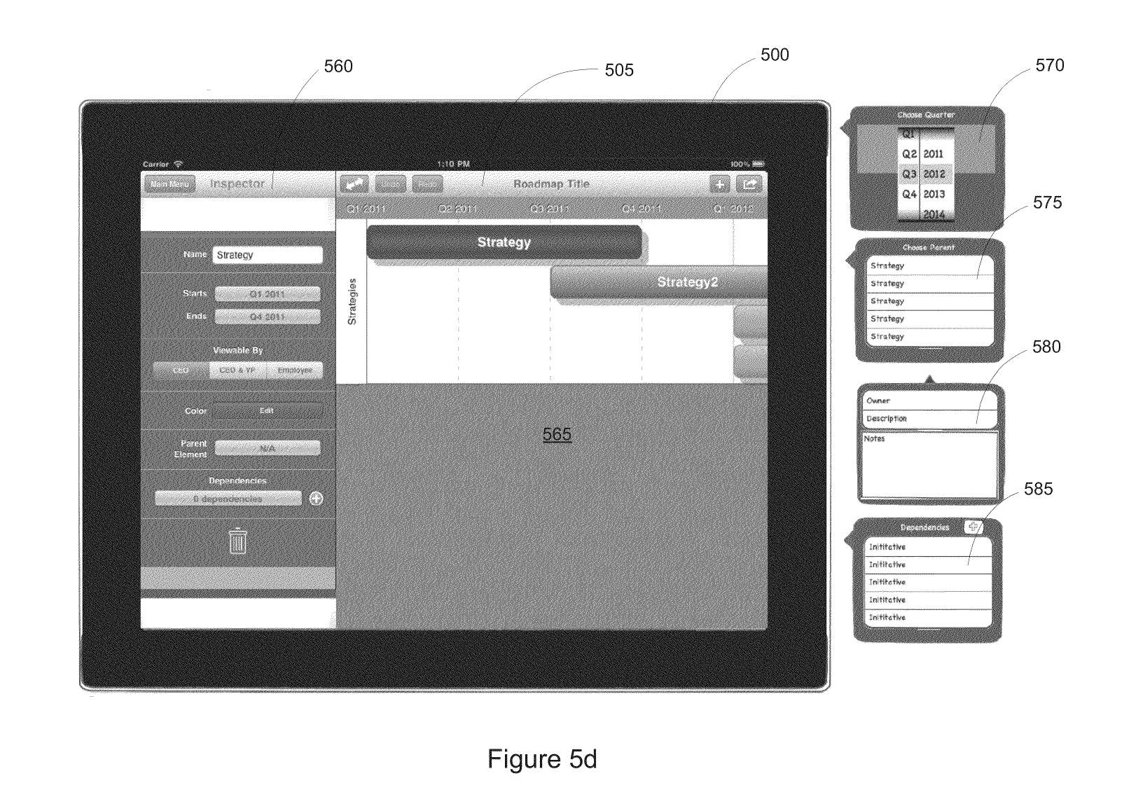

Various embodiments may be implemented as a strategy tool, such as a standalone application, or a networked application, etc., on electronic devices having displays such as tablet PCs, e.g., the Apple iPad®. FIG. 5a illustrates such an electronic device 500 having a display 505. within which various embodiments may be implemented. The electronic device 500 includes the display 505 in the form of, e.g., a liquid crystal display, a housing, a battery, one or more communication ports and/or an antenna, a smart card and card reader, radio interface circuitry, codec circuitry , a controller/processor and a memory (not shown). The above-described components enable the electronic device to send/receive various messages to/from other devices that may reside on a network in accordance with the various embodiments of the present invention. It should be noted that the controller/processor and/or another processor along with related circuitry/elements may be utilized to effectuate various embodiments, and individual circuits and elements are all of a type well known in the art, for example in the Nokia range of mobile telephones.

Upon a user executing the application, a main menu is displayed on the display 505. Options displayed on the main menu include an “Open Roadmap” option 510, which presents a document browser to the user to allow the user to begin creating a new roadmap, editing/manipulating an existing roadmap, etc. A “Training Videos” option 515 navigates to a video browser through which a user may view instructional videos that instruct the user how to use the application, e.g., create roadmaps. A “Settings” option 520 directs the user to a settings and administration page, where the user may define or set settings and administration parameters, such as, e.g., password protection, setting color options, etc. Additionally, an “About” option 525 directs a user to information about, e.g., the application itself, such as version number, disclaimers, license information, links to an informational website, etc. More or less options may be presented to a user in the menu, and selecting an option may be effected by the user touching the menu option, or performing some appropriate action to select the desired option.

FIG. 5b illustrates the electronic device 500 and the display 505, which in this instance, is displaying a settings page to a user. The settings page may include a settings menu 530 that provides different settings options that a user may adjust. For example, a user may define certain colors on color settings pane 535 that the user may wish to utilize for elements on a roadmap.

Additionally, the user may wish to brand a roadmap with a particular company logo. For example, if a roadmap is printed, the printed copy of the roadmap will appear with the company logo. Company logos may be manually transferred or downloaded to the electronic device 500 in an appropriate graphical format. Alternatively, company logos, or any other type of graphical branding may be stored on the electronic device 500, e.g., when taken by a camera on the electronic device 500, where a storage of the electronic device 500 is accessed by the user. Further still, a user may wish to define security settings, such as setting a default security for exporting a roadmap to, e.g., a print copy, another electronic device, etc., and navigation buttons, e.g., back and forward buttons, may also be presented to a user to allow that user to move to and from different pages, main menu options, etc.

FIG. 5c illustrates the electronic device 500 with the display 505. In this instance, a document browser is being presented to a user. In accordance with various embodiments, the document browser is utilized to view roadmap templates or existing roadmaps already created by a user. The document browser displayed to the user may include a document browser menu 540, which allows the user to select whether he/she wishes to view roadmap templates or any existing templates. It should be noted that these categories may be further delineated into sub-categories or other, e.g., hierarchical, structure to provide efficient and convenient access to these documents. For example, selecting a particular template category, e.g., a Health Care Project Template, may present a roadmap template, or if more than one roadmap template exists that may be categorized as a Health Care Project Template, a sub-menu may appear presenting those additional roadmap templates to the user. It should also be noted that roadmaps/documents, as well as templates (which will be subsequently discussed in greater detail) may be stored as XML documents.

A roadmap template chosen by the user is displayed on a document preview pane 545. Alternatively to the displaying of additional roadmap templates/existing roadmaps for selection in the document browser menu 540, such additional roadmap templates/existing roadmaps may be displayed directly on the document preview pane 545. When being displayed in the document browser, roadmap templates/existing roadmaps may be associated with one or more informational aspects, such as a training video 550 that may be configured to pop up upon the user selecting/actuating an information button 555. Additionally, the training video(s) 550 may be directly accessed via the Training Video option 515 presented on the main menu illustrated in FIG. 5a. It should be noted that none, one or more information buttons may be associated with one or more elements in a roadmap template/existing roadmap.

The training video 550 may be a generic training video instructing a user regarding general strategy or may be specific to a particular roadmap template/existing roadmap. For example, generalized instructions and/or an overview video may be provided for roadmap templates regarding how a user may proceed with creating a roadmap, or targeted, but still generalized instructions regarding the particular roadmap template specifics. Alternatively still, the training video 550 may be a custom or user-generated video associated with, e.g., an existing roadmap. That is, a manager may be tasked with collaborating on a particular existing CxO-level strategy. Selecting the information button 555 of an existing roadmap created for that CxO-level strategy may present a video of the CxO providing additional instructions to that manager.

Upon a particular roadmap template or existing roadmap being selected by a user, the user is presented with a roadmap editor. FIG. 5d illustrates such an exemplary roadmap editor on the electronic device 550. On the display 505, an inspector pane 560 is presented along with a roadmap pane 565. The inspector pane 560 is configured to present one or more attributes of an element selected from a roadmap (i.e., a roadmap template or existing roadmap) for viewing and/or editing, and may be hidden or displayed in accordance with a user's desires/needs. Such attributes may include, but are not limited to the following: name of the strategy; start and end periods/times; accessibility properties, e.g., what user(s) may view/edit the attributes; a color/shading associated with the strategy; a parent element if one/more exists; and any dependencies on that element. Additionally, the inspector pane 560 allows the user to delete one or more elements from the roadmap.

The user may view and/or edit one or more of these attributes. It should be noted that in the case of, e.g., an existing roadmap, one or more attributes may only be available for viewing, not editing. For example, the timeline of a roadmap may have been set by the creator of that roadmap to be un-editable. In accordance with another embodiment, color selection may be limited to top-level elements only, such that once a color is chosen for a parent strategy, that same color is propagated to children strategies/initiatives. Screens 570, 575, 580, and 585 are exemplary popup windows that may appear when the user selects a particular attribute in the inspector pane 560. Screen 570 is representative of timeline selection, where the user may view and/or edit start and/or end times for a particular element. Screen 575 is representative of a parent strategy selector, where the user may align a particular strategy or initiative with, e.g., a parent strategy. Screen 580 represents a popup window through which the user may view/enter/edit additional information, data, properties related to a roadmap element, as described previously. For example, the user may enter his/her name as an owner of the element/roadmap, a description of the strategy, any notes regarding the particular strategy or roadmap, etc. Screen 585 is representative of a popup window that allows the user to view/edit one or more dependencies associated with a particular roadmap element/strategy. It should be noted that in accordance with other embodiments, such popup windows may be replaced with drop-down menus in the inspector pane 560, or some other appropriate interactive representation.

More or less control may be given to a user regarding viewing and/or editing a roadmap and the elements therein. For example, a user may be given control to undo or redo one or more actions applied in the roadmap editor. Swimlanes may be added or deleted from a roadmap template or existing roadmap if allowed, as well as elements that may be added or deleted from a particular swimlane. Further still, and as described previously, the user may otherwise manipulate the roadmap by, e.g., effectuating various actions such as pinching, zooming, adjusting, sliding, etc., the roadmap, and elements within the roadmap. That is, a user may scroll timelines left and right to view un-displayed portions of a roadmap, as well as effect screen management in accordance with the user's desires/needs. Regarding zooming, a user may change the zoom scale on a time basis.

Additionally, the user may be given the option to export the displayed roadmap to, e.g., a printer, a particular file format, etc., or send the roadmap to another device, user, etc. If the roadmap is to be exported to, e.g., a file format such as the Adobe® PDF format, a company logo may be integrated into the roadmap. For example, and as described previously, the user may configure the application to brand a roadmap, where such a company logo (or other picture/graphic) will appear in a certain portion of the exported roadmap. Additionally, the roadmap may be named by the user, where the name may also appear on one or more portions of the exported roadmap. A company name, copyright information, etc. may also be included in the exported roadmap. It should also be noted that the exported roadmap may be rendered automatically to fit a defined space, or otherwise optimized for display.

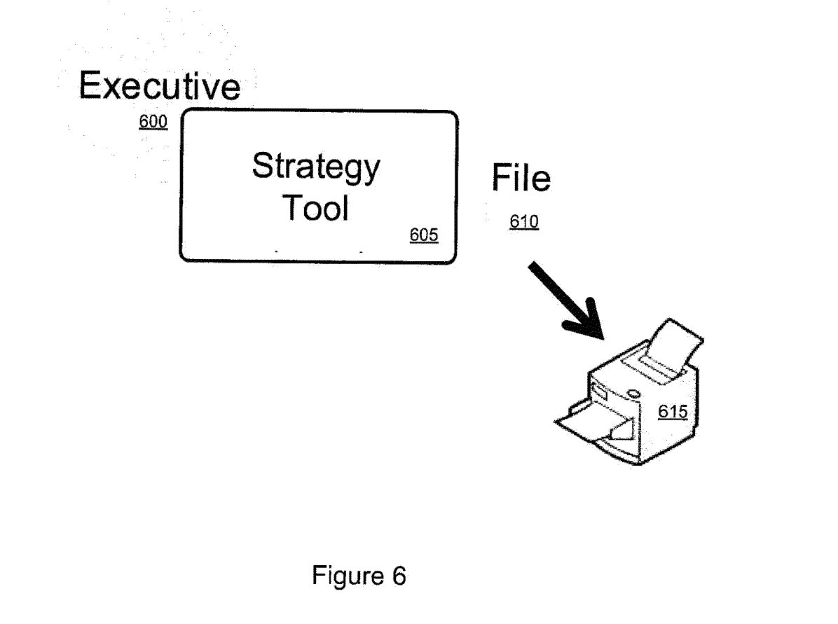

In accordance with one embodiment, the strategy tool may be implemented as a standalone application/tool for strategic planning FIG. 6 illustrates an exemplary system architecture in accordance with this embodiment. An executive 600 utilizes the strategy tool on an electronic device 605, such as the aforementioned Apple iPad®. The strategy tool in this embodiment may be a standalone application that is loaded onto and executed on the electronic device 605. In order to communicate one or more roadmaps associated with one or more business strategies, the strategy tool exports the one or more roadmaps as a file, such as a PDF file. The PDF-formatted file may then be stored on a storage/memory unit accessible by the electronic device 605, such as internal solid-state memory drives, or a removable memory, such as flash memory unit. The PDF-formatted file representative of the one or more roadmaps may then be transferred to another computing device connected to a printer 615 for printing. Alternatively, utilizing the electronic device's internal/resident communication capabilities, the PDF-formatter file may be emailed or otherwise communicated to another device, user, output peripheral, etc.

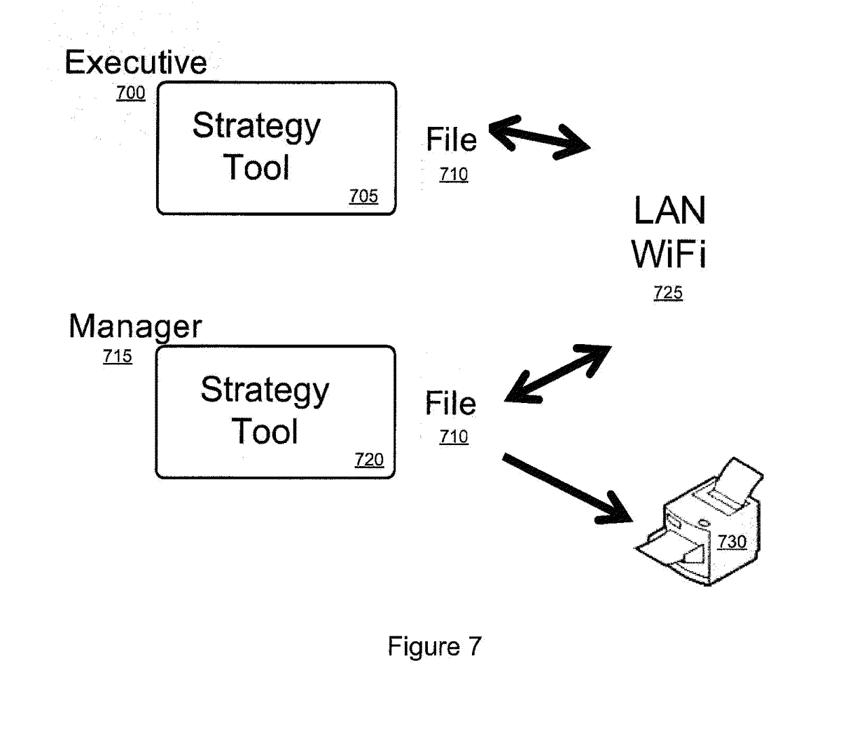

In accordance with another embodiment, the strategy tool may be implemented as an application on an electronic device having communication capabilities, such as WiFi or other local area network (LAN) connectivity. In this embodiment, “localized” collaboration can be achieved. FIG. 7 illustrates another exemplary system architecture in accordance with this embodiment. A first user, e.g., an executive 700, utilizes an instance of the strategy tool on his/her electronic device 705, while a second user, e.g., a manager 715, utilizes another instance of the strategy tool on his/her electronic device 720. Collaboration between the executive 700 and the manager 715 is achieved by exchanging file 710, which is representative of one or more business strategies. The file 710 may be shared between the executive 700 and the manager 715 via a LAN, using WiFi capabilities of their respective electronic devices 705 and 720. As is the case with the prior embodiment, the file 710 may be printed on a printer 730 or outputted in some tangible format using, e.g., another presentation-based peripheral. For example, the collaborative roadmap may be displayed through either of the electronic devices 705 or 720 by connecting one of the electronic devices 705 or 720 to, e.g., a projector, or the file may be stored, as described above, on a removable memory unit and transferred to another computing device for presentation. Moreover, and in addition to the functionality described above, users may comment on a roadmap and provide dynamic feedback to each other, as well as dynamically update/edit the roadmap between each other.

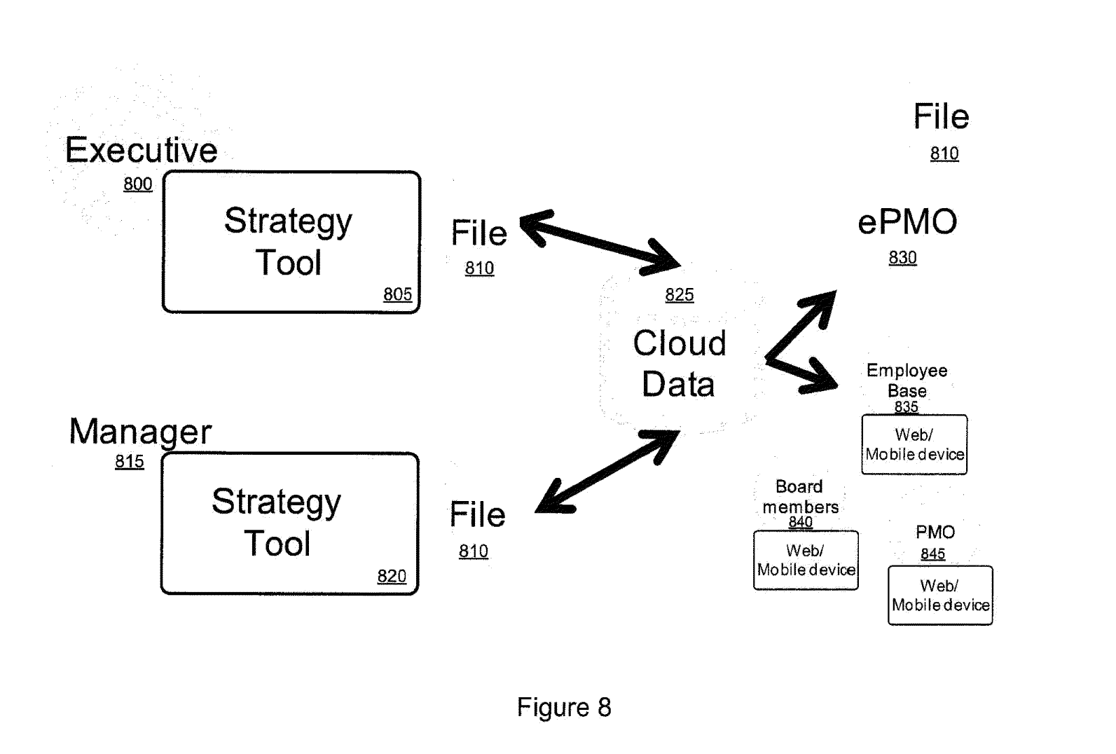

In accordance with yet another embodiment, corporate collaboration may be achieved using a cloud-based system architecture. FIG. 8 illustrates an exemplary system architecture, where like the architecture described in FIG. 7, a first user, e.g., an executive 800, utilizes an instance of the strategy tool on his/her electronic device 805, while a second user, e.g., a manager 815, utilizes another instance of the strategy tool on his/her electronic device 820. Collaboration between the executive 800 and the manager 815 is achieved by exchanging file 810, which is representative of one or more business strategies. However, instead of utilizing LAN connectivity, communications are achieved using a cloud network, where file 810 (a representation of one or more roadmaps) is stored as cloud data 825 on multiple server computers. Additionally, the instances of the strategy tool may not necessarily be implemented as client-specific applications on the electronic devices 805 and 820, but rather as an application executed and managed by, e.g., a web browser of the electronic devices 805 and 820, with no actual, installed client version of the application.

Moreover, other aspects of an organization may gain access to business strategies. For example, FIG. 8 illustrates that an enterprise project management office (ePMO) 830, in addition to the executive 800 and manager 815, may gain access to the file 810. Depending on the needs and/or desires of the particular company/business, the ePMO 830 may also be given the authority or ability to not only access/view a roadmap, but participate in its development, comment on it, edit it, etc.

Further still, the company employee base 835 may also be given the ability to view, edit, comment, etc. on a roadmap through the Web or a mobile device. For example, lower-level employees that might not ordinarily have a hand in developing business strategy may, e.g., access a particular roadmap through the Web 840 and leave comments for the executive 800, the manager 815, etc. Additionally, board members 840 and a particular project management office 845 may also access, edit, comment, etc. on a roadmap. It should be noted that the number and/or types of personnel or entities that may access and/or otherwise interact with a roadmap is unlimited, and may be configured in accordance with access settings as discussed above.

In practice, the executive 800 may initially develop a strategy using the strategy tool in accordance with various embodiments as described herein. The strategy, represented in one or more roadmaps may then be forwarded to the manager 815, e.g., a middle manager. Once the manager is aware of/understands the strategy, the one or more representative roadmaps may then be associated with one or more strategic initiatives as described herein to achieve the overall strategy promulgated by the executive 800. The one or more roadmaps (now including the overall strategy as well as strategic initiatives) may be forwarded to the employee base 835, board members 840, and/or one or more PMOs 845. As described previously, communication of a business strategy is paramount to success in business, and using the cloud-based system architecture illustrated in FIG. 8, corporate customers, employees, corporate governance bodies, etc., are able to easily see the business strategy being developed and/or implemented. Moreover, executives may add and/or adjust business strategies over a multi-year timeline, while middle management may acknowledge the strategy changes and adjust their own execution plans and budgets. Further still, downstream views by, e.g., the employee base, board members, etc., are able to receive business strategy updates over time and associated strategic initiatives that require execution on their part.

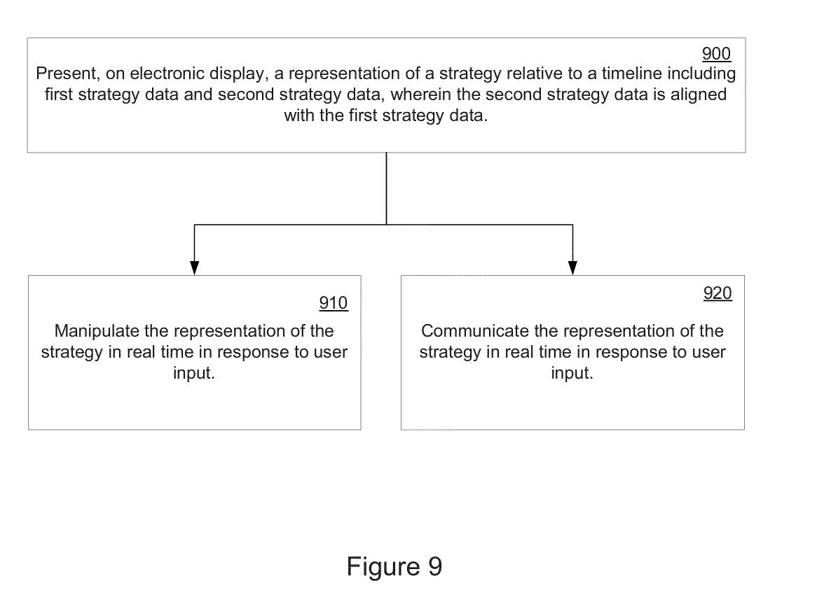

FIG. 9 illustrates exemplary processes performed for utilizing the strategy tool in accordance with various embodiments. At 900, a representation of a strategy relative to a timeline including first strategy data and second strategy data, wherein the second strategy data is aligned with the first strategy data, is presented to, e.g., a user or other relevant entity. At 910, the representation of the strategy may be manipulated in real time. As described above, manipulation of the representation may refer to using control metaphors such as a pinching the representation as it is displayed on the electronic display to zoom out so that more of the strategy may be viewed. Other manipulation may involve zooming in on the strategy using another control action, editing the strategy by, e.g., adding swimlanes, removing swimlanes, aligning child and parent swimlanes, etc. Alternatively and/or in addition to the manipulation of the representation of the strategy, the representation of the strategy may be communicated to one or more other users/entities in real time at 920. For example, and as also described above, the strategy representation may be communicated to another user, entity, or group(s) of users/entities using a devices communication capabilities, such as email via WiFi/LAN connectivity, broadcasting the representation via web browser, etc.

Various embodiments may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

Data may be communicated between the various systems, computers/servers and engines of various embodiments in real time over the Internet or other computer network environment using logical connections to one or more remote computers having processors. Logical connections may include a LAN and a wide area network (WAN) that are presented here by way of example and not limitation. Such networking environments are commonplace in office-wide or enterprise-wide computer networks, intranets and the Internet. It will be appreciated that such network computing environments will typically encompass many types of computer system configurations, including personal computers, hand-held devices, multi-processor systems, microprocessor-based or programmable consumer electronics, network PCs, minicomputers, mainframe computers, and the like. Systems in accordance with various embodiments may also be implemented in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It will be further be appreciated that the systems in accordance with various embodiments may perform fewer or additional functions as compared to those described herein. For example, an entity (e.g., a secondary mortgage market participant) that performs only some of the above-mentioned processes may use a computer system that contains only a subset of the functions described herein. Additionally, one or more of the systems or functions may be variously combined in alternative configurations.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
presenting, on an electronic display, a representation of a strategy relative to a timeline including first strategy data and second strategy data, wherein the second strategy data is aligned with the first strategy data; and
at least one of manipulating and communicating the representation of the strategy in real time in response to user input.

2. The method of claim 1, wherein the electronic display comprises a mobile computer device display.

3. The method of claim 1, wherein the representation of the strategy comprises a visual roadmap.

4. The method of claim 3, wherein the roadmap comprises a first swimlane element representative of the first strategy data and a second swimlane element representative of the second strategy data.

5. The method of claim 4 further comprising, visually relating the first swimlane element and the second swimlane element to effectuate the alignment of the second strategy data with the first strategy data.

6. The method of claim 1, wherein the first strategy data comprises parent strategy data and the second strategy data comprises child strategy data, the first strategy data and the second strategy data being indicative of a hierarchical strategy.

7. The method of claim 1, wherein the first strategy data is indicative of a top-level strategy.

8. The method of claim 1, wherein the second strategy data is indicative of at least one of a top-level strategic initiative, a business unit strategy initiative, and a departmental strategic initiative.

9. The method of claim 1 further comprising, presenting third strategy data related to at least one of the first strategy data and the second strategy data, wherein the third strategy data is un-aligned with the at least one of the first strategy data and the second strategy data.

10. The method of claim 1, wherein the manipulating of the representation of the strategy comprises at least one of visually adjusting the presentation of the representation of the strategy and editing at least one of the first strategy data and the second strategy data.

11. The method of claim 1, wherein the communicating of the representation of the strategy comprises transmitting the representation of the strategy via at least one of a removable storage medium, a local area network, and a cloud-based network.

12. A computer-readable memory including computer executable instructions, the computer executable instructions, when executed by a processor, cause an apparatus to perform a method as claimed in claim 1.

13. An apparatus, comprising:
at least one processor; and
at least one memory including computer program code, the at least one memory and the computer program code configured to, with the at least one processor, cause the apparatus to perform at least the following:
present, on an electronic display, a representation of a strategy relative to a timeline including first strategy data and second strategy data, wherein the second strategy data is aligned with the first strategy data; and
at least one of manipulate and communicate the representation of the strategy in real time in response to user input.

14. The apparatus of claim 13, wherein the apparatus comprises a mobile computer device that includes the electronic display.

15. The apparatus of claim 13, wherein the representation of the strategy comprises a visual roadmap.

16. The apparatus of claim 15, wherein the roadmap comprises a first swimlane element representative of the first strategy data and a second swimlane element representative of the second strategy data.

17. The apparatus of claim 16, wherein the at least one memory and the computer program code configured to, with the at least one processor, cause the apparatus to further perform at least the following:
visually relate the first swimlane element and the second swimlane element to effectuate the alignment of the second strategy data with the first strategy data.

18. The apparatus of claim 13, wherein the first strategy data comprises parent strategy data and the second strategy data comprises child strategy data, the first strategy data and the second strategy data being indicative of a hierarchical strategy.

19. The apparatus of claim 13, wherein the first strategy data is indicative of a top-level strategy.

20. The apparatus of claim 13, wherein the second strategy data is indicative of at least one of a top-level strategic initiative, a business unit strategy initiative, and a departmental strategic initiative.

21. The apparatus of claim 13, wherein the at least one memory and the computer program code configured to, with the at least one processor, cause the apparatus to further perform at least the following:
present third strategy data related to at least one of the first strategy data and the second strategy data, wherein the third strategy data is un-aligned with the at least one of the first strategy data and the second strategy data.

22. The apparatus of claim 13, wherein the manipulating of the representation of the strategy comprises causing the apparatus to at least one of visually adjust the presentation of the representation of the strategy and edit at least one of the first strategy data and the second strategy data in response to additional user input.

23. The apparatus of claim 13, wherein the communicating of the representation of the strategy comprises causing the apparatus to transmit the representation of the strategy via at least one of a removable storage medium, a local area network, and a cloud-based network.
